(19) United States
(12) Patent Application Publication
(10) Pub. No.: US 2021/0215046 A1
(43) Pub. Date: Jul. 15, 2021

(54) TURBINE AND THRUST LOAD ADJUSTING METHOD

(71) Applicant: TOSHIBA ENERGY SYSTEMS & SOLUTIONS CORPORATION, Kawasaki-shi (JP)

(72) Inventors: Tsuguhisa TASHIMA, Yokohama Kanagawa (JP); Takahiro ONO, Ota Tokyo (JP); Shogo IWAI, Ota Tokyo (JP); Tomomi OKUYAMA, Ota Tokyo (JP); Hideyuki MAEDA, Yokohama Kanagawa (JP); Koki NISHIMURA, Kawasaki Kanagawa (JP)

(73) Assignee: TOSHIBA ENERGY SYSTEMS & SOLUTIONS CORPORATION, Kawasaki-shi (JP)

(21) Appl. No.: 17/113,938

(22) Filed: Dec. 7, 2020

(30) Foreign Application Priority Data
Jan. 10, 2020 (JP) 2020-002671

(51) Int. Cl. F01D 3/04; F04D 29/051

(52) U.S. Cl. CPC F01D 3/04; F04D 29/0516; F05D 2220/31; F05D 2240/55; F05D 2260/15; F05D 2240/52

(57) ABSTRACT

According to an embodiment, a turbine comprises: a casing; a rotor shaft; turbine stages; a thrust bearing which receives thrust load in the axial direction generated by a flow of a working fluid supplied to the turbine stages; a balance piston which is formed on the rotor shaft along a circumferential direction and projects in a radial direction from the rotor shaft, for adjusting a thrust contact pressure; and a thrust load adjusting mechanism which applies pressures of a pressure-increasing side and a pressure-decreasing side to at least one of a balance piston inner-side chamber and a balance piston outer-side chamber which sandwich the balance piston in the axial direction.

### CROSS-REFERENCE TO RELATED APPLICATION

This application is based upon and claims the benefit of priority from Japanese Patent Application No.2020-002671 filed on Jan. 8, 2020, the entire content of which is incorporated herein by reference.

### FIELD

Embodiments of this invention relate to a turbine and a thrust load adjusting method.

### BACKGROUND

Axial turbines include a single-flow type and a double-flow type. For the same flow rate, the blade length of the single-flow turbine is longer, while the blade length of the double-flow turbine is shorter. The single-flow turbine is more often adopted since a turbine having a larger blade length has higher performance.

Working fluid of a turbine decreases in pressure as it works at each stage. As a result, owing to a difference between pressures on the front and rear sides of the flow, force in an axial direction from high-pressure side toward low-pressure side acts on rotor blades of the turbine. Axial-direction force also acts on a rotor shaft at its part where its diameter changes. Such forces acting on the rotor blades and the rotor shaft in passages of the working fluid as a whole become thrust load as propulsive force acting on the rotor shaft in the axial direction. Because of the above, the thrust load is force directed from the high-pressure side toward the low-pressure side, for example, under rated power, it is force directed from working fluid inlet side toward exhaust side.

To counterbalance this thrust load, a large-diameter part called a balance piston is provided on a rotor shaft. One surface of the balance piston is set in a high-pressure side and its other surface is set in a low-pressure side, and force in a direction opposite the direction of the aforesaid thrust load is generated. Such balance piston is disclosed in WO2018/109810, the entire content of which is incorporated herein by reference.

A thrust bearing receives the thrust load. There is a proper range of a contact pressure applied to the thrust bearing. Proper values differ depending on the kind of the thrust bearing, and are, for example, around 10 kg/cm², or around 20 kg/cm² to around 30 kg/cm². The thrust bearing needs to be used under the contact pressure within the proper range according to each condition.

Because of a demand for performance improvement of a turbine, an inlet pressure of the turbine under the rated operation condition tends to increase. As a result, a variation range of the inlet pressure of the turbine in the start-up process tends to be large.

FIG. 14 is a graph illustrating an example of a variation in contact pressure of a thrust bearing in the start-up process. The horizontal axis represents the start-up process of a turbine, and represents electrical power after the turbine bears a load. The vertical axis represents the contact pressure P applied to the thrust bearing. In the graph, the upper side of 0 level of the vertical axis represents a contact pressure due to thrust load in a direction from inlet side toward exhaust side (hereinafter, the contact pressure toward the exhaust side), and the lower side thereof represents a contact pressure due to thrust load in a direction from the exhaust side toward the inlet side (hereinafter, the contact pressure toward the inlet side). FIG. 14 illustrates the case of a CO₂ gas turbine as an example.

The allowable contact pressure range A shown in FIG. 14 is an allowable range of the contact pressure toward the exhaust side of the turbine. The lower limit contact pressure P_{AL} is set to maintain the safe operation of the turbine, and the upper limit contact pressure P_{AU} is set to avoid excessive application of the contact pressure. The allowable contact pressure range B is an allowable range of the contact pressure toward the inlet side of the turbine. The lower limit contact pressure P_{BL} is set to maintain the safe operation of the turbine, and the upper limit contact pressure P_{BU} is set to avoid excessive application of the contact pressure.

The solid line L represents the variation in the contact pressure P applied to the thrust bearing in the start-up process. In the power operation, the force toward the exhaust side of the turbine increases as the operation progresses toward a rated power. On the other hand, in an initial period of the start-up of the turbine, there is a stage in which the force in the opposite direction, that is, the force toward the inlet side of the turbine increases.

As a result, as for the contact pressure P applied to the thrust bearing, in the initial period of the start-up process of the turbine, there is a stage where the contact pressure from the exhaust side toward the inlet side of the turbine increases as indicated by L_{A} part of the solid line. Specifically, an absolute value of the contact pressure becomes larger than the upper limit contact pressure P_{BU} of the allowable contact pressure range B to fall out of the allowable contact pressure range B. Thereafter, the force in this direction decreases, so that the contact pressure returns to the allowable contact pressure range B as indicated by L_{B} part of the solid line and then becomes lower than the lower limit contact pressure P_{BL} of the allowable contact pressure range B, and the direction of the force reverses, so that the direction of the contact pressure P applied to the thrust bearing changes toward the exhaust side.

As the operation further progresses toward the rated output, the contact pressure toward the exhaust side increases to fall within the allowable contact pressure range A and thereafter becomes still higher to fall out of the allowable contact pressure range A.

As described above, there are problems that, in the start-up process of the turbine, the initial contact pressure toward the turbine inlet side and the subsequent contact pressure toward the exhaust side are both generated and the contact pressures in both directions may fall out of the allowable contact pressure ranges even in the presence of the balance piston.

In the above description, the case of the CO₂ gas turbine is exemplified, but the same situation may also occur in other gas turbines or steam turbines. However, in conventional methods, it is difficult to avoid the situation in which the contact pressures in both directions are generated in the start-up process of the turbine and these pressures greatly fall out of the allowable contact pressure ranges because of their large variation ranges, or the configuration becomes complicated.

### BRIEF DESCRIPTION OF THE DRAWINGS

FIG. 1 is a system diagram illustrating the configurations of a turbine system including a turbine and a thrust load adjusting mechanism according to a first embodiment.

FIG. 2 is an axial-direction sectional view of the upper half of the turbine according to the first embodiment.

FIG. 3 is an explanatory conceptual instrumentation system diagram of the configuration of the thrust load adjusting mechanism of the turbine according to the first embodiment.

FIG. 4 is a block diagram illustrating the configuration of the controller of the thrust load adjusting mechanism of the turbine according to the first embodiment.

FIG. 5 is a flowchart illustrating the procedure of a thrust load adjusting method according to the first embodiment.

FIG. 6 is a conceptual characteristic chart illustrating an example of a relation between the contact pressure applied to the thrust bearing and the temperature thereof in the turbine according to the first embodiment.

FIG. 7 is a block diagram illustrating the configuration of the controller of a thrust load adjusting mechanism of a turbine according to a second embodiment.

FIG. 8 is a flowchart illustrating the procedure of a thrust load adjusting method of the turbine according to the second embodiment.

FIG. 9 is a graph illustrating a first example of how the thrust load adjusting mechanism of the turbine according to the second embodiment changes the contact pressure of the thrust bearing in the start-up process.

FIG. 10 is a graph illustrating a second example of how the thrust load adjusting mechanism of the turbine according to the second embodiment changes the contact pressure of the thrust bearing in the start-up process.

FIG. 11 is an axial-direction sectional view of the upper half of a turbine according to a third embodiment.

FIG. 12 is a system diagram illustrating the configurations of a turbine system including a turbine and a thrust load adjusting mechanism according to a fourth embodiment.

FIG. 13 is an axial-direction sectional view of the upper half of the turbine according to the fourth embodiment.

FIG. 14 is a graph illustrating an example of a variation in contact pressure of a thrust bearing in the start-up process.

### DETAILED DESCRIPTION

An object of embodiments of the present invention is to maintain the contact pressure of a thrust bearing within an allowable contact pressure range without relying on complicated configuration.

According to an aspect of the present invention, there is provided a turbine comprising: a casing; a rotor shaft penetrating the casing; a plurality of turbine stages arranged in the casing along an axial direction of the rotor shaft; a thrust bearing which receives thrust load in the axial direction generated by a flow of a working fluid supplied to the turbine stages; a balance piston which is formed on the rotor shaft along a circumferential direction and projects in a radial direction from the rotor shaft, to alleviate a thrust contact pressure applied to the thrust bearing; and a thrust load adjusting mechanism which applies pressures of a pressure-increasing side and a pressure-decreasing side to at least one of a balance piston inner-side chamber and a balance piston outer-side chamber which sandwich the balance piston in the axial direction.

According to an aspect of the present invention, there is provided a thrust load adjusting method of a turbine including a balance piston which is formed in a rotor shaft along a circumferential direction and projects in a radial direction from the rotor shaft, to adjust a thrust contact pressure applied to a thrust bearing, the method comprising: a thrust contact pressure estimating step of deriving, by a thrust contact pressure calculating unit, a thrust contact pressure estimated value from a measurement value related to an operation state; a set value reading step of reading, by a thrust contact pressure controller, a thrust bearing contact pressure set value from a thrust contact pressure calculation data storage; a deviation calculating step of subtracting, by a subtracting unit of the thrust contact pressure controller, the thrust contact pressure estimated value from the thrust bearing contact pressure set value to output a thrust contact pressure deviation; and a control calculation step of performing, by a control element of the thrust contact pressure controller, a control calculation based on the thrust contact pressure deviation, and outputting an opening position command signal to an control valve which applies pressures of a pressure-increasing side and a pressure-decreasing side to at least one of a balance piston inner-side chamber and a balance piston outer-side chamber which sandwich the balance piston in an axial direction.

With reference to the accompanying drawings, a turbine and a thrust load adjusting method according to embodiments of the present invention will be described. The parts that are the same as, or similar to, each other are represented by the same reference symbols and will not be described repeatedly.

[First Embodiment]

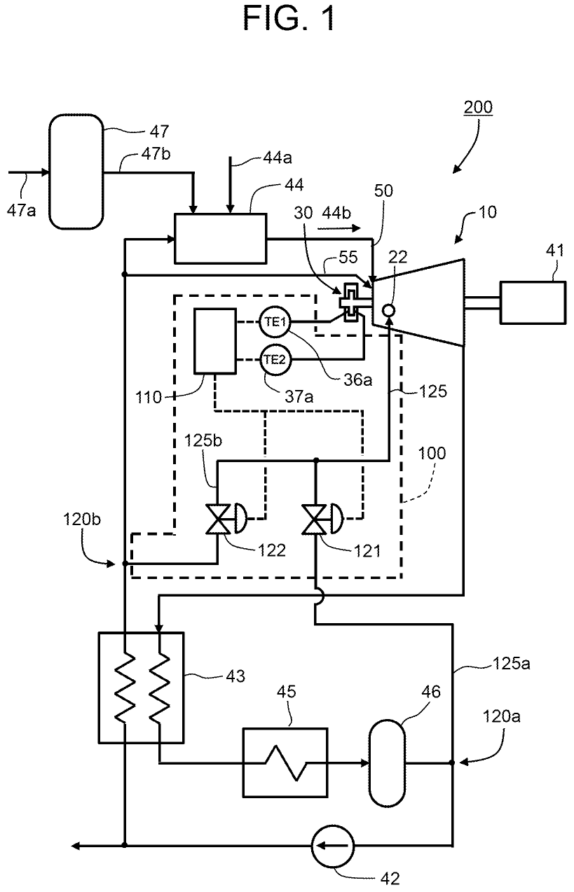

FIG. 1 is a system diagram illustrating the configurations of a turbine system 200 including a turbine 10 and a thrust load adjusting mechanism 100 in the turbine 10 according to a first embodiment.

In the following description, a system using a CO₂ gas turbine is taken as an example of the turbine system 200, but it should be noted that the features of the thrust load adjusting mechanism 100 in this embodiment is also applicable to other gas turbines and steam turbines.

The turbine system 200 has the turbine 10 including the thrust load adjusting mechanism 100, a generator 41 driven by the turbine 10, a compressor 42, a regenerative heat exchanger 43, a combustor 44, a cooler 45, a moisture separator 46, and an oxygen producer 47.

The combustor 44 receives oxygen 47b produced by the oxygen producer 47 from air 47a, a fuel 44a supplied from a not-illustrated storage, and a CO₂ gas that has recirculated in the system and passed through the regenerative heat exchanger 43, and burns them to generate high-temperature working fluid 44b. The working fluid 44b is combustion gas mainly containing the CO₂ gas and partly water vapor and is introduced to the turbine 10 through a transition piece 50 connecting the combustor 44 and the turbine 10.

The turbine 10 receives the high-temperature working fluid 44b, converts thermal energy of the working fluid 44b into mechanical energy, that is, rotational energy, and transmits the rotational energy to the generator 41 that converts it into electric power.

To improve thermal energy efficiency in the turbine system 200, the regenerative heat exchanger 43 heat-exchanges the working fluid, which is discharged from the turbine 10 after working in the turbine 10, with the recirculated CO₂ gas that has been cooled in the cooler 45 and pressurized in the compressor 42.

The cooler 45 cools the working fluid discharged from the turbine 10 and decreased in temperature due to the heat exchange in the regenerative heat exchanger 43. This cooling condenses the water vapor in the working fluid.

The moisture separator 46 removes moisture, into which the water vapor has been condensed, from the working fluid. The compressor 42 pressurizes the CO₂ gas produced with removing the moisture in the working fluid in the moisture separator 46, and pumps it out.

The pressurized CO₂ gas is partly discharged out of the system, and the CO₂ gas for recirculation flows into the regenerative heat exchanger 43 to be heated and thereafter is supplied to the combustor 44. Here, part of the CO₂ gas flowing out from the regenerative heat exchanger 43 branches off before it flows into the combustor 44, and passes through a cooling medium supply pipe 55 to directly flow into the turbine 10, where it acts as cooling medium.

The thrust load adjusting mechanism 100 has a low pressure-side pipe 125a, a high pressure-side pipe 125b, an adjusting pipe 125, a first low pressure-side control valve 121, a first high pressure-side control valve 122, a controller 110, a thrust bearing receiving member first face thermometer 36a, and a thrust bearing receiving member second face thermometer 37a.

As described above, a pressure in pipes from a discharge side of the compressor 42 to an inlet of the combustor 44 is higher than the pressure in pipes from an exhaust side of the turbine 10 to a suction side of the compressor 42. Therefore, the pipes and devices from the exhaust side of the turbine 10 to the suction side of the compressor 42 will be called a low-pressure region 120a, and the pipes and devices from the discharge side of the compressor 42 to the inlet of the combustor 44 will be called a high-pressure region 120b.

The low pressure-side pipe 125a has one end connected to the low-pressure region 120a. The high pressure-side pipe 125b has one end connected to the high-pressure region 120b. FIG. 1 illustrates an example in which the low pressure-side pipe 125a is connected to outlet side of the moisture separator 46 and the inlet side of the compressor 42 in the low-pressure region 120a, and the high pressure-side pipe 125b is connected to a position that is the outlet side of the compressor 42 and outlet side of the regenerative heat exchanger 43 in the high-pressure region 120b. It should be noted that the connection part of the low pressure-side pipe 125a in the low-pressure region 120a and the connection part of the high pressure-side pipe 125b in the high-pressure region 120b are not limited to these places as will be described later.

The low pressure-side pipe 125a and the high pressure-side pipe 125b are connected to each other at their ends opposite the aforesaid connection parts and join into the single adjusting pipe 125. One side opposite their connection part, of the adjusting pipe 125, is connected to a balance piston outer-side chamber 22 of the turbine 10. It should be noted that the low pressure-side pipe 125a and the high pressure-side pipe 125b each may be independently connected to the balance piston outer-side chamber 22 of the turbine 10 instead of joining into the single adjusting pipe 125.

A first low pressure-side control valve 121 and a high pressure-side control valve 122 are disposed on the low pressure-side pipe 125a and the high pressure-side pipe 125b respectively.

The thrust bearing receiving member first face thermometer 36a and the thrust bearing receiving member second face thermometer 37a are provided for the thrust bearing 30.

Based on outputs of the thrust bearing receiving member first face thermometer 36a and the thrust bearing receiving member second face thermometer 37a, the controller 110 outputs an opening or closing command signal to the first low pressure-side control valve 121 and the high pressure-side control valve 122 to adjust thrust load applied to the thrust bearing 30 within a proper range.

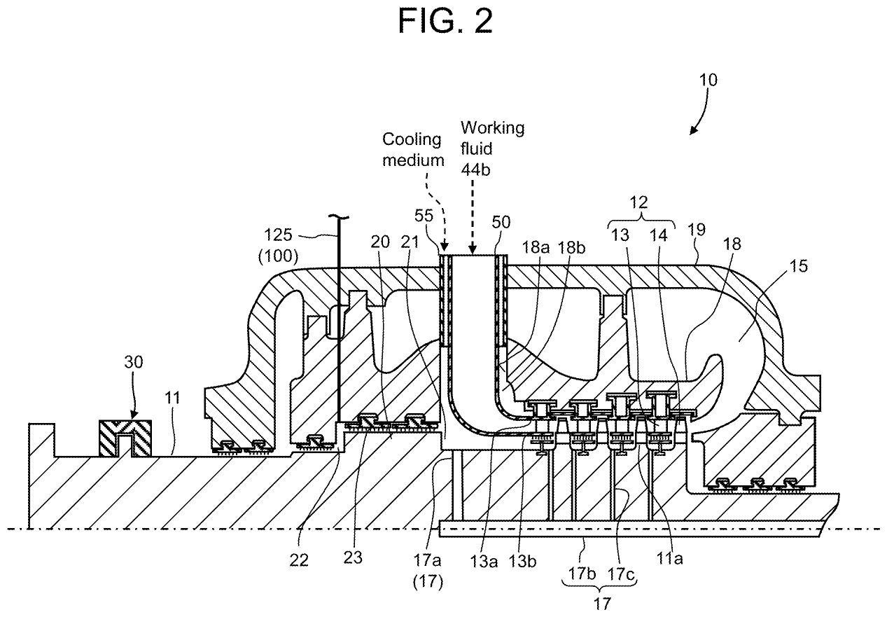

FIG. 2 is an axial-direction sectional view of the upper half of the turbine 10 according to the first embodiment.

The turbine 10 is an axial turbine and has a rotor shaft 11, an inner casing 18, an outer casing 19, the transition piece 50, and the cooling medium supply pipe 55.

On the inner periphery of the inner casing 18, a plurality of outer shrouds 13a each disposed all along the circumferential direction are arranged at intervals in a direction in which a rotation axis of the rotor shaft 11 extends (hereinafter, the axial direction) . Further, inner shrouds 13b each disposed all along the circumferential direction are arranged on radially inner side of the outer shrouds 13a, that is, on the side closer to the rotation axis of the rotor shaft 11. Between each of the outer shrouds 13a and the corresponding inner shroud 13b, a plurality of stator blades 13 are arranged in the circumferential direction to constitute a stator blade cascade.

Further, on the rotor shaft 11, a plurality of radially projecting turbine disks 11a in a disk shape are formed at intervals in the axial direction. Rotor blades 14 are implanted in each of the turbine disks 11a and are arranged in the circumferential direction to constitute a rotor blade cascade. The rotor blade cascades are arranged at intervals in the axial direction.

The stator blade cascades and the rotor blade cascades are alternately arranged in the axial direction of the rotor shaft 11. Each of the stator blade cascades and the directly downstream rotor blade cascade thereof, in terms of a direction in which the working fluid flows, constitute a turbine stage 12.

The transition piece 50 passes through the outer casing 19 and the inner casing 18 of the turbine 10. A downstream end of the transition piece 50 is in contact with upstream ends of the outer shroud 13a and the inner shroud 13b supporting the initial-stage stator blades 13. The transition piece 50 guides the working fluid 44b generated in the combustor 44 (FIG. 1) to the initial-stage stator blades 13. After working in the turbine stages 12, the working fluid flows into an exhaust chamber 15 and flows out of the turbine 10 from the exhaust chamber 15.

In a penetration region where the transition piece 50 passes through the outer casing 19 and the inner casing 18, the outer periphery of the transition piece 50 is covered with the cooling medium supply pipe 55 guiding the cooling medium. That is, in the penetration region, the transition piece 50 and the cooling medium supply pipe 55 disposed on the outer side of the transition piece 50 form a double pipe.

To prevent the cooling medium flowing in an annular passage between the transition piece 50 and the cooling medium supply pipe 55 from flowing into space between the outer casing 19 and the inner casing 18, a downstream end of the cooling medium supply pipe 55 extends up to a through hole 18a formed in the inner casing 18. The through hole 18a is an opening through which the transition piece 50 and the cooling medium supply pipe 55 are inserted into the inner casing 18. The inside diameter of the through hole 18a corresponds to the outer shape of the cooling medium supply pipe 55, and has such a dimension as to allow the cooling medium supply pipe 55 to be inserted in the through hole 18a and to make as little gap as possible. In this part, a fitting structure, for example, a spigot joint or the like may be formed to more ensure the connection.

An outlet of the cooling medium supply pipe 55 communicates with a cooling medium inlet space 18b that is space, in the inner casing 18, in which the transition piece 50 is inserted. That is, the cooling medium guided by the cooling medium supply pipe 55 flows into the cooling medium inlet space 18b.

It should be noted that the structure for supplying the cooling medium to the cooling medium inlet space 18b is not limited to this. That is, as long as the cooling medium can be supplied to the cooling medium inlet space 18b, it may be a structure with those passing through the outer casing 19 and the inner casing 18 separately from the transition piece 50, instead of the structure disposed around the transition piece 50.

The cooling medium supplied to the cooling medium inlet space 18b is supplied to the turbine stages 12 downstream of the initial-stage stator blades 13 by a cooling structure 17. The cooling structure 17 has an axial passage 17b formed in the axial direction in the rotor shaft 11, a passage inlet hole 17a through which the cooling medium inlet space 18b and the axial passage 17b communicate with each other, and passage outlet holes 17c through which the axial passage 17b and the turbine stages 12 communicate with each other.

A balance piston 20 is provided on the rotor shaft 11 to reduce a thrust load applied to the thrust bearing 30. On the inner casing 18, a balance piston seal 23 is provided on its part on radially outer side of the balance piston 20. The balance piston seal 23 includes a plurality of labyrinths formed as illustrated in FIG. 2.

A balance piston inner-side chamber 21 is a space, in the turbine 10, facing an inner-side end of the balance piston 20. The balance piston inner-side chamber 21 is the cooling medium inlet space 18b communicating with the cooling medium supply pipe 55. A balance piston outer-side chamber 22 is space opposite to the aforesaid space across the balance piston 20; that is, facing an end of the balance piston 20 opposite the inner-side end. The balance piston outer-side chamber 22 is outer-side space of the inner casing 18 in terms of the axial direction.

As illustrated in FIG. 2, the adjusting pipe 125 passes through the outer casing 19 and the inner casing 18 and its one open end is in the balance piston outer-side chamber 22. With this configuration, the balance piston outer-side chamber 22 communicates with the low-pressure region 120a and the high-pressure region 120b through the first low pressure-side control valve 121 and the first high pressure-side control valve 122 which are illustrated in FIG. 1.

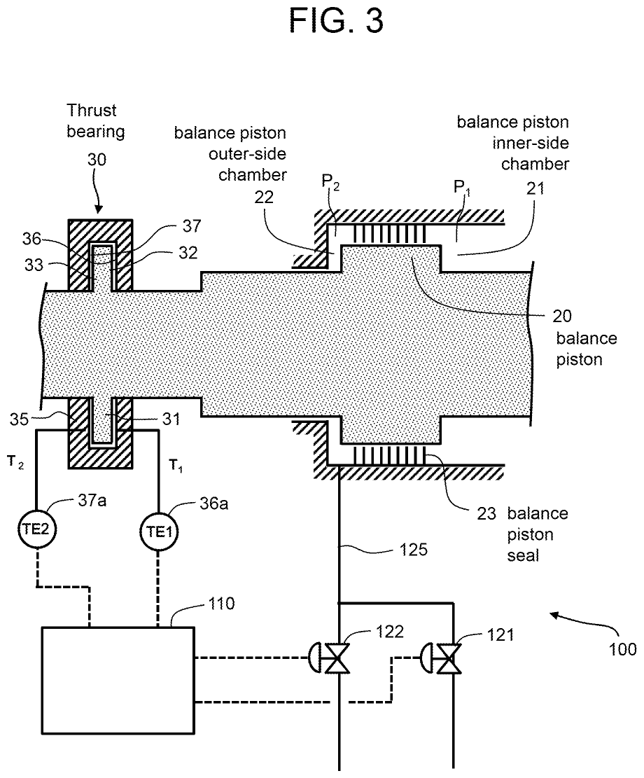

FIG. 3 is an explanatory conceptual instrumentation system diagram of the configuration of the thrust load adjusting mechanism 100 of the turbine 10 according to the first embodiment.

The thrust bearing 30 is disposed on axially outer side of the outer casing 19 and has a rotation-side disk 31 and a thrust bearing receiving member 35.

The rotation-side disk 31 has a disk shape and projects radially outward from the rotor shaft 11. The thrust bearing receiving member 55 surrounds the rotation-side disk 31 from axially front and rear sides and a radially outer side of the rotation-side disk 31.

Hereinafter, in expressing the direction, the direction in which the working fluid flows in the turbine stages 12 will be called the exhaust-side direction, and the opposite direction as the inlet-side direction.

The rotation-side disk 31 has a rotation-side disk first face 32 of its exhaust-side and a rotation-side disk second face 33 of its inlet-side opposite the rotation-side disk first face 32. The thrust bearing receiving member 35 has a thrust bearing receiving member first face 36 that is its inlet-side plane and a plane that faces the rotation-side disk first face 32, and a thrust bearing receiving member second face 37 that faces the rotation-side disk second face 33.

The thrust bearing receiving member first face thermometer 36a and the thrust bearing receiving member second face thermometer 37a measure the temperatures of the thrust bearing receiving member first face 36 and the thrust bearing receiving member second face 37 respectively and output the measurement results to the controller 110. Specifically, it is possible to measure the surface temperature of the thrust bearing receiving member first face 36 by, for example, inserting the thrust bearing receiving member first face thermometer 36a into a hole that is formed from the outer side of the thrust bearing receiving member 35 up to the vicinity of the surface of the thrust bearing receiving member first face 36. The same applies to the thrust bearing receiving member second face thermometer 37a.

Specifically, the thrust bearing receiving member first face thermometer 36a measures the temperature of the vicinity of the surface of the thrust bearing receiving member first face 36 especially in a state in which the rotation-side disk 31 is pressed toward the exhaust side and a contact pressure is generated between the rotation-side disk first face 32 and the thrust bearing receiving member first face 36. The thrust bearing receiving member second face thermometer 37a measures the temperature of the vicinity of the surface of the thrust bearing receiving member second face 37 especially in a state in which the rotation-side disk 31 is pressed toward the inlet side and a contact pressure is generated between the rotation-side disk second face 33 and the thrust bearing receiving member second face 37.

In the following, P₁ and P₂ represent the pressure in the balance piston inner-side chamber 21 and the pressure in the balance piston outer-side chamber 22 respectively.

The balance piston inner-side chamber 21 communicates with the balance piston outer-side chamber 22 through the balance piston seal 23, and the balance piston outer-side chamber 22 further communicates with the outside of the outer casing 19 through a seal part on its outer side. Therefore, the pressure P₂ in the balance piston outer-side chamber 22 in a natural state is a pressure in the middle of a pressure gradient from the balance piston outer-side chamber 22 up to the outer side of the outer casing 19. Note that the natural state here refers to a state without the adjustment performed by the thrust load adjusting mechanism 100.

It should be noted that the connection part of the low pressure-side pipe 125a in the low-pressure region 120a and the connection part of the high pressure-side pipe 125b in the high-pressure region 120b are not limited to the places illustrated in FIG. 1. The connection parts may be other places as long as the connection part in the low-pressure region 120a has a pressure level enabling to apply such a pressure as to decrease the pressure in the balance piston outer-side chamber 22 from the natural state, and as long as the connection part in the high-pressure region 120b has a pressure level enabling to apply such a pressure as to increase the pressure in the balance piston outer-side chamber 22 from the natural state.

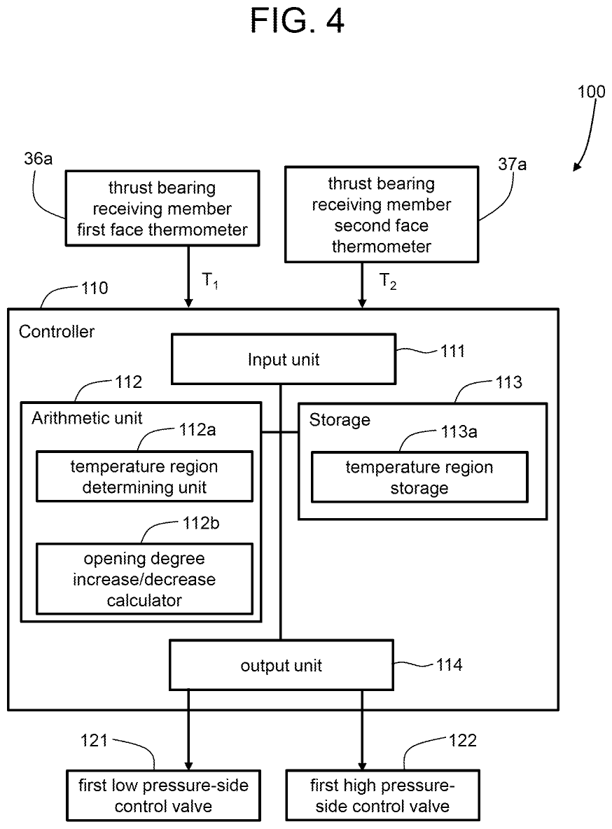

FIG. 4 is a block diagram illustrating the configuration of the controller 110 of the thrust load adjusting mechanism 100 of the turbine 10 according to the first embodiment.

The controller 110 has an input unit 111, an arithmetic unit 112, a storage 113, and an output unit 114.

The input unit 111 receives temperature signals T₁, T₂ from the thrust bearing receiving member first face thermometer 36a and the thrust bearing receiving member second face thermometer 37a and also receives data stored in the storage 113 as an external input.

The arithmetic unit 112 has a temperature region determining unit 112a and an opening position increase/decrease calculator 112b. The temperature region determining unit 112a determines whether the temperature signals T₁, T₂ from the thrust bearing receiving member first face thermometer 36a and the thrust bearing receiving member second face thermometer 37a have values indicating that the state may be maintained or that the contact pressure falls out of an allowable contact pressure range and a correction operation is needed. The opening position increase/decrease calculator 112b performs an arithmetic operation to determine whether or not the opening positions of the first low pressure-side control valve 121 and the first high pressure-side control valve 122 need to be increased or decreased.

The storage 113 is a memory and has a temperature region storage 113a. The temperature region storage 113a provides a criterion for the determination by the temperature region determining unit 112a.

The output unit 114 outputs the arithmetic operation result in the opening position increase/decrease calculator 112b, that is, the arithmetic operation result regarding the necessity or not for the increase or decrease of the opening positions of the first low pressure-side control valve 121 and the first high pressure-side control valve 122, to the first low pressure-side control valve 121 and the first high pressure-side control valve 122.

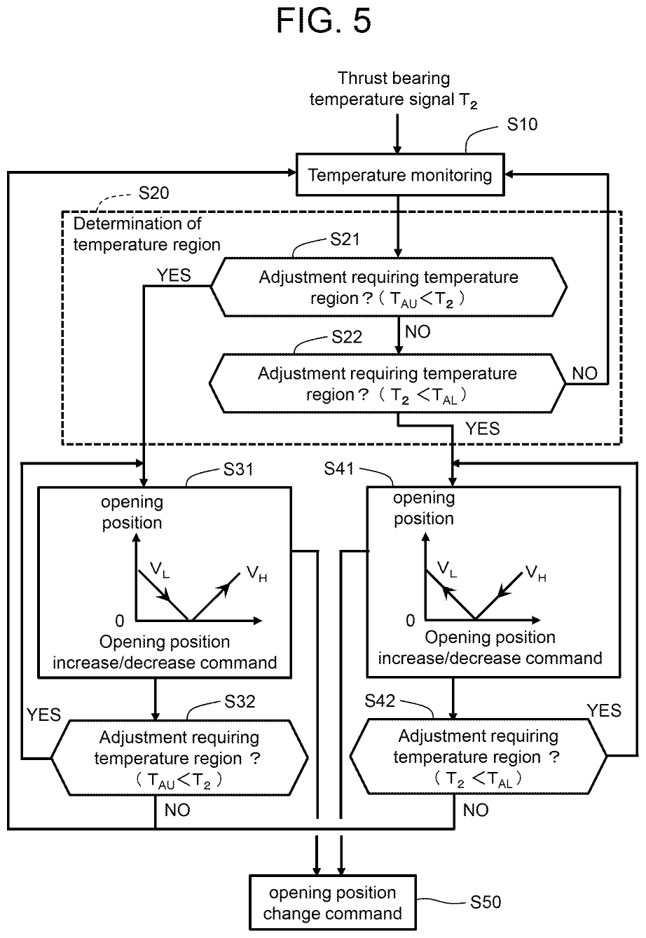

FIG. 5 is a flowchart illustrating the procedure of a thrust load adjusting method according to the first embodiment. That is, it illustrates the procedure of the thrust load adjusting method using the controller 110 of the thrust load adjusting mechanism 100 according to the first embodiment. Note that FIG. 5 illustrates, as an example, the adjusting method regarding the temperature signal T₂ from the thrust bearing receiving member second face thermometer 37a, but the following description also applies to the adjusting method regarding the temperature signal T₁ from the thrust bearing receiving member first face thermometer 36a.

The controller 110 constantly continues temperature monitoring (Step S10). That is, the input unit 111 constantly receives the temperature signal T₂ from the thrust bearing receiving member second face thermometer 37a.

Regarding the received temperature signal T₂, the temperature region is determined (Step S20). Specifically, the temperature region determining unit 112a determines whether or not the value T₂ of the received temperature signal falls out of a normal range to be in a region requiring the adjustment.

In the above, the case in which the temperature region determining unit 112a determines whether or not the values T₁ and T₂ of the received temperature signals fall out of the normal ranges to be in the regions requiring the adjustment is taken as an example, but this is not restrictive. For example, it may be determined whether or not a difference between T₁ and T₂, that is, an absolute value of (T₁-T₂) falls out of a normal range to be in a region requiring the adjustment. In this case, information on a magnitude relation between T₁ and T₂ is necessary. This magnitude relation may be determined based on information indicating a current stage in the start-up process, such as a power of the turbine 10 or the generator 41, for instance.

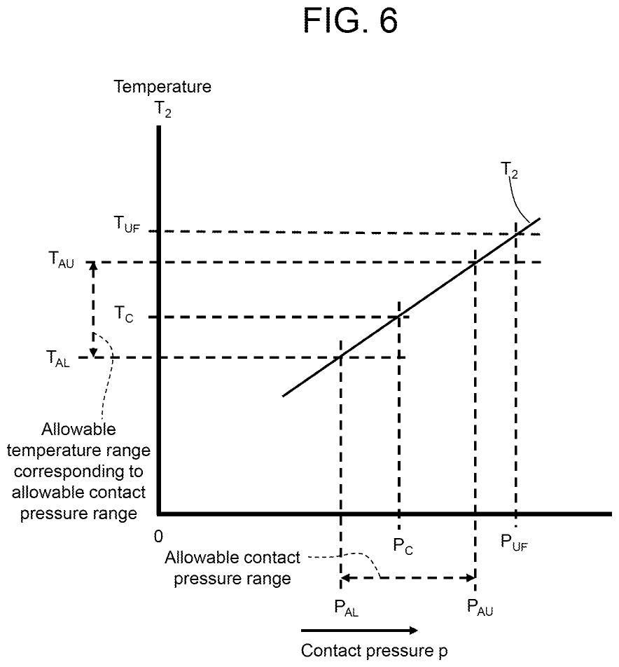

FIG. 6 is a conceptual characteristic chart illustrating an example of a relation between the contact pressure P applied to the thrust bearing 30 and the temperature T thereof in the turbine 10 according to the first embodiment. The horizontal axis represents the contact pressure P and the vertical axis represents the temperature T corresponding to the contact pressure P, of the contact side in the thrust bearing 30.

FIG. 6 illustrates, as an example, the temperature T₂ when the contact pressure P is generated between the rotation-side disk second face 33 and the thrust bearing receiving member second face 37. It is also possible to adjust the thrust load by the same method described below, regarding the temperature T₁ when the contact pressure is generated in the opposite direction between the rotation-side disk first face 32 and the thrust bearing receiving member first face 36.

P_{AU} on the horizontal axis in FIG. 6 represents the upper limit of the allowable contact pressure range. P_{AL} represents the lower limit of the allowable contact pressure range. P_{C} means a normal contact pressure falling within the allowable contact pressure range of higher than P_{AL} and lower than P_{AU}. Further, P_{UF} represents a contact pressure upper limit critical value, a contact pressure at and over which is not permissible. That is, the upper limit P_{AU} of the allowable contact pressure has tolerance for the upper limit critical value P_{UF}.

T_{UF}, T_{AU}, T_{c}, and T_{AL} on the vertical axis represent temperatures when the contact pressures P_{UF}, P_{AU}, P_{C}, and P_{AL} are applied to the thrust bearing 30 respectively.

In more detail, at Step S20, based on temperature region data stored in the temperature region storage 113a, the temperature region determining unit 112a first determines whether or not the value of the received temperature signal T₂ falls out of the allowable temperature range of not lower than T_{AL} nor higher than T_{AU} to a high-temperature side to be in the adjustment requiring temperature region exceeding the upper limit temperature T_{AU} (Step S21) . Here, the adjustment requiring temperature region refers to a temperature region falling out of the allowable temperature range, that is, both a temperature region lower than the allowable temperature range and a temperature region higher than the allowable temperature range.

If it is not determined at Step S21 that the temperature is in the adjustment requiring temperature region (Step S21 NO), the temperature region determining unit 112a determines whether or not the value of the received temperature signal T₂ falls out of the allowable temperature range of not lower than T_{AL} nor higher than T_{AU} to the low-temperature side and is lower than the lower limit temperature T_{AL} to be in the adjustment requiring region (Step S22).

If it is not still determined at Step S22 that the value is in the adjustment requiring region (Step S22 NO), Step S10 and Step S20 are repeated.

If the temperature region determining unit 112a determines at Step S21 that the value of the received temperature signal T₂ exceeds the upper limit temperature T_{AU} of the allowable temperature range and falls out of the allowable temperature range to the high-temperature side to be in the adjustment requiring temperate region (Step S21 YES), the opening position increase/decrease calculator 112b performs an arithmetic operation to generate an opening position increase/decrease command (Step S31).

That the value of the temperature signal T₂ falls out of the allowable temperature range to the high-temperature side here means that the thrust toward the inlet side (the leftward direction in FIG. 2 and FIG. 3) is excessive. To solve this, it is necessary to increase the pressure P₂ in the balance piston outer-side chamber 22 that is the space on the outer side of the balance piston 20.

Therefore, the opening position increase/decrease calculator 112b issues an output indicating that the opening positions of the first low pressure-side control valve 121 and the first high pressure-side control valve 122 should be changed to increase the pressure P₂ in the balance piston outer-side chamber 22. Here, the opening/closing states of the first low pressure-side control valve 121 and the first high pressure-side control valve 122 are in split range as illustrated in the block of Step S31 in FIG. 5.

Specifically, to increase the pressure P₂ in the balance piston outer-side chamber 22, the opening position increase/decrease calculator 112b outputs an opening position command signal for decreasing the opening position of the first low pressure-side control valve 121 connected to the low-pressure region 120a (FIG. 1) (Step S31).

Upon receiving the opening position change command signal output by the opening position increase/decrease calculator 112b, the output unit 114 outputs the opening position change command to the first low pressure-side control valve 121 and the first high pressure-side control valve 122 (Step S50). Specifically, it is output to controllers, positioners, or drivers of the first low pressure-side control valve 121 and the first high pressure-side control valve 122. As a result, the opening position of the first low pressure-side control valve 121 is changed to a lower side. Note that when the opening position of the first low pressure-side control valve 121 is zero or more, the first high pressure-side control valve 122 is fully closed.

The decrease in the opening position of the first low pressure-side control valve 121 decreases the flow rate of the cooling medium flowing out from the balance piston outer-side chamber 22 to the low-temperature region 120a according to the decremental amount of the opening position. This results in a decrease in the flow rate in a flow path from the balance piston inner-side chamber 21 up to the balance piston outer-side chamber 22 through the labyrinths 23. Since a pressure loss in the balance piston seal 23 decreases as a result, the pressure P₂ in the balance piston outer-side chamber 22 approaches the pressure P₁ in the balance piston inner-side chamber 21, that is, the pressure P₂ in the balance piston outer-side chamber 22 increases.

The temperature region determining unit 112a determines whether or not the value of the temperature signal T₂ is still in the adjustment requiring temperature region (Step S32). Specifically, it determines whether or not the value of the temperature signal T₂ is still in the adjustment requiring temperature region exceeding the upper limit temperature T_{AU}. If it is determined that the value of the temperature signal T₂ is still in the adjustment requiring temperature region (Step S32 YES), Step S31 and Step S32 are repeated.

If it is determined that the value of the temperature signal T₂ is still in the adjustment requiring temperature region even when the first low pressure-side control valve 121 is fully closed, the opening position increase/decrease calculator 112b outputs an opening position command signal for increasing the opening position of the first high pressure-side control valve 122 connected to the high-pressure region 120b (FIG. 1).

The increase in the opening position of the first high pressure-side control valve 122 increases the flow rate of the cooling medium flowing into the balance piston outer-side chamber 22 from the high-pressure region 120b according to an incremental amount of the opening position. This results in a decrease in the flow rate in the flow path from the balance piston inner-side chamber 21 up to the balance piston outer-side chamber 22 through the labyrinths 23. As a result, the pressure P₂ in the balance piston outer-side chamber 22 increases as it does when the opening position of the first low pressure-side control valve 121 is decreased.

The foregoing describes the flow when the temperature region determining unit 112a determines that the value of the received temperature signal T₂ falls out of the allowable temperature range to the high-temperature side to be in the adjustment requiring temperature region. On the other hand, if the temperature region determining unit 112a determines at Step S22 that the value of the received temperature signal T₂ falls out of the allowable temperature range to the low-temperature side to be in the adjustment requiring temperature region (Step S22 YES), the opening position increase/decrease calculator 112b similarly performs an arithmetic operation to generate the opening position increase/decrease command to output it (Step S41).

That the value of the temperature signal T₂ falls out of the allowable temperature range to the low-temperature side here means that the thrust load toward the inlet side (the leftward direction in FIG. 2 and FIG. 3) is excessively small. Therefore, to solve this, it is necessary to decrease the pressure P₂ in the balance piston outer-side chamber 22 that is the space on the outer side of the balance piston 20.

Therefore, the opening position increase/decrease calculator 112b issues an output indicating that the opening positions of the first low pressure-side control valve 121 and the first high pressure-side control valve 122 should be changed to decrease the pressure P₂ in the balance piston outer-side chamber 22.

Specifically, to decrease the pressure P₂ in the balance piston outer-side chamber 22, the opening position increase/decrease calculator 112b outputs an opening position command signal for decreasing the opening position of the first high pressure-side control valve 122 connected to the high-pressure region 120b (FIG. 1). Further, after the first high pressure-side control valve 122 becomes fully closed, an opening position command signal for increasing the opening position of the first low pressure-side control valve 121 connected to the low-pressure region 120a (FIG. 1) is output as required.

Upon receiving the opening position change command signal output by the opening position increase/decrease calculator 112b, the output unit 114 outputs the opening position change command to the first low pressure-side control valve 121 and the first high pressure-side control valve 122 (Step S50).

The temperature region determining unit 112a determines whether or not the value of the temperature signal T₂ is still in the adjustment requiring temperature region (Step S42). Specifically, it determines whether or not the value of the temperature signal T₂ is still in the adjustment requiring temperature region below the lower limit temperature T_{AL}. If it is determined that the value of the temperature signal T₂ is still in the adjustment requiring temperature region (Step S42 YES), Step S41 and Step S42 are repeated.

Here, a thermometer usually has a time constant of approximately several ten seconds to approximately several minutes when its wire is not in direct contact with a measurement target. Therefore, the opening position increase/decrease command from the output unit 114 is output at a time delay several times as long as the time constant of the thermometer. Further, an opening position variation width per output is set small enough to prevent the control from overshooting excessively.

If the temperature region determining unit 112a determines that the level of the temperature signal T₂ is lower than the upper limit value T_{AU} (Step S32 YES) and if the temperature region determining unit 112a determines that the level of the temperature signal T₂ is higher than the lower limit value T_{AL} (Step S42 YES), the controller 110 returns to Step S10 to continue the temperature monitoring.

In the thrust load adjusting mechanism 100 in this embodiment as configured above, the adjusting pipe 125 is connected to the balance piston outer-side chamber 22, so that the balance piston outer side chamber 22 can communicate with the low-pressure region 120a and the high-pressure region 120b, and the pressures derived from the low-pressure region 120a and the high-pressure region 120b, that is, the pressures of the pressure-increasing side and the pressure-decreasing side can be applied thereto. As a result, the pressure P₂ in the balance piston outer-side chamber 22 is changeable from the natural-state pressure P_{2N} both in the increasing direction and the decreasing direction, making it possible to adjust the contact pressure P of the thrust bearing 30 to a wide range and in a required direction. Further, the first low pressure-side control valve 121 and the first high pressure-side control valve 122 whose one-side ends are connected to the low-pressure region 120a and the high-pressure region 120b respectively join into the single adjusting pipe 125 at the other sides, leading to a reduction in the number of pipes near the turbine 10, which is advantageous in routing the pipes.

As described above, according to the first embodiment of the present invention, it is possible to adjust the contact pressure of the thrust bearing 30 within the allowable contact pressure range without relying on complicated configuration.

[Second Embodiment]

A second embodiment is a modification of the first embodiment and is the same as the first embodiment except in that the configuration of a controller 110a is different from that of the first embodiment.

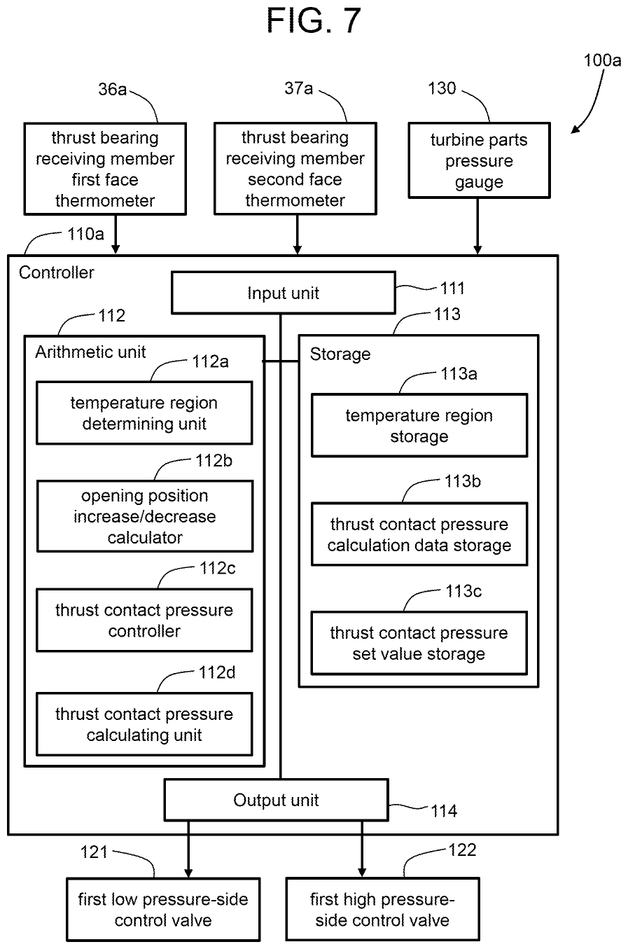

FIG. 7 is a block diagram illustrating the configuration of the controller 110a of a thrust load adjusting mechanism 100a of a turbine 10 according to the second embodiment.

The controller 110a has an input unit 111, an arithmetic unit 112, a storage 113, an output unit 114, and measuring devices.

The input unit 111 receives temperature signals from a thrust bearing receiving member first face thermometer 36a and a thrust bearing receiving member second face thermometer 37a and a pressure signal from a turbine parts pressure gauge 130, and also receives data stored in the storage 113 as an external input. The turbine parts pressure gauge 130 here is a generic term and includes pressure gauges for measuring not only pressures in a balance piston inner-side chamber 21 and a balance piston outer-side chamber 22 (FIG. 2) but also, for example, a pressure of a working fluid in a transition piece 50 and a pressure in an exhaust chamber 15.

Here, the thrust bearing receiving member first face thermometer 36a, the thrust bearing receiving member second face thermometer 37a, and the pressure gauges for the balance piston inner-side chamber 21 and the balance piston outer-side chamber 22 that the controller 110a has are included in the controller 110a, but this is not restrictive, and instruments for finding the operation state, such as these thermometers, pressure gauges, or an instrument that finds a value corresponding to a load of the turbine 10 may be provided outside the controller 110a.

Since the controller 110a itself may measure the operation state or may receive a value measured or detected externally to recognize the operation state, they will be collectively called a recognizing unit.

Further, the measurement values of the pressure gauges for the balance piston inner-side chamber 21 and the balance piston outer-side chamber 22 may be replaced by a differential pressure therebetween. However, information on a magnitude relation between the pressure in the balance piston inner-side chamber 21 and the pressure in the balance piston outer-side chamber 22 is necessary. This magnitude relation between the pressure in the balance piston inner-side chamber 21 and the pressure in the balance piston outer-side chamber 22 may be determined based on information on which stage a current state is in the start-up process, such as a power of the turbine 10 or the generator 41.

The arithmetic unit 112 has a temperature region determining unit 112a, an opening position increase/decrease calculator 112b, a thrust contact pressure controller 112c, and a thrust contact pressure calculating unit 112d.

The temperature region determining unit 112a determines whether or not thrust bearing temperatures T₁, T₂ fall within an adjustment requiring temperature region, as in the first embodiment.

Based on the results of the monitoring of the thrust bearing temperatures T₁, T₂, the opening position increase/decrease calculator 112b performs a correction operation when the thrust bearing temperatures T₁, T₂ enter the adjustment requiring temperature region, as in the first embodiment.

The thrust contact pressure controller 112c is a control circuit having a control element and a subtracting unit and performs a control calculation based on a deviation of a thrust contact pressure.

The thrust contact pressure calculating unit 112d calculates an estimated value of the thrust contact pressure applied to a thrust bearing 30 based on values of the pressures in the parts of the turbine 10 measured by the turbine parts pressure gauge 130.

The storage 113 is a memory and has a thrust contact pressure calculation data storage 113b and a thrust contact pressure set value storage 113c besides a temperature region storage 113a that is the same as that of the first embodiment.

The thrust contact pressure calculation data storage 113b stores attribute data and so on necessary for the calculation by the thrust contact pressure calculating unit 112d, such as pressure receiving areas of the parts of the turbine 10.

The thrust contact pressure set value storage 113c memorizes and stores a thrust contact pressure set value. In this case, the set value of the thrust contact pressure maybe a fixed value in an allowable contact pressure range. Alternatively, the set value may be a value that differs depending on each stage of the start-up process of the turbine 10. In this case, the input unit 111 receives a measurement value indicating a state in an output stage, for example, a value measured by a wattmeter, and then a value corresponding to this stage in the thrust contact pressure set value storage 113c may be used as the set value.

The output unit 114 outputs, as an command signal, the result of the arithmetic operation by the arithmetic unit 112 to a first low pressure-side control valve 121 and a first high pressure-side control valve 122.

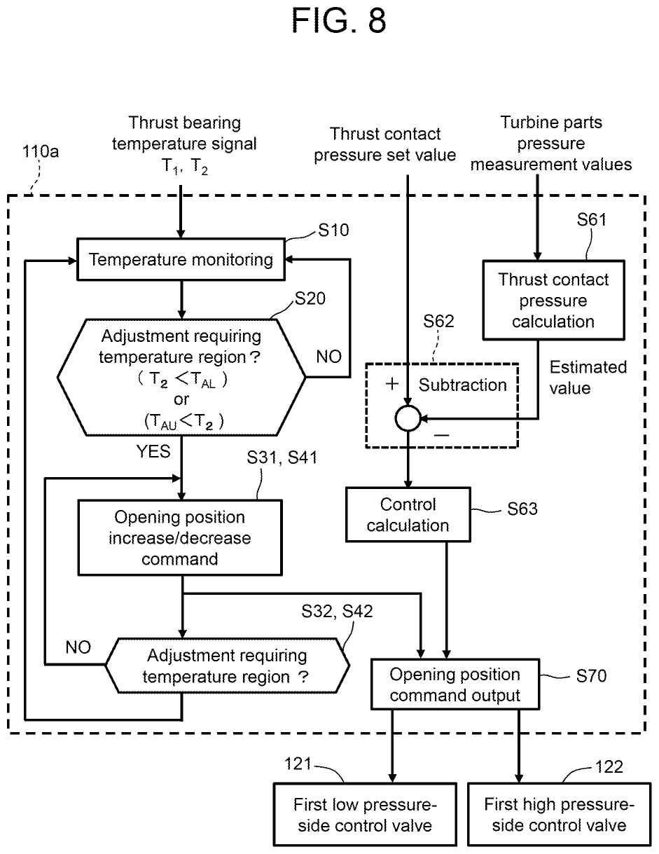

FIG. 8 is a flowchart illustrating the procedure of a thrust load adjusting method of the turbine 10 according to the second embodiment.

Roughly, the method includes steps of thrust contact pressure control from Steps S61 to S63 and thrust bearing temperature compensation at and after Step S10.

In the thrust contact pressure control, first, the thrust contact pressure calculating unit 112d calculates the estimated value of the thrust bearing contact pressure based on the turbine parts pressure measurement values received from the turbine parts pressure gauge 130, using the data stored in the thrust contact pressure calculation data storage 113b (Step S61).

FIG. 8 illustrates, as an example, the case where the thrust bearing contact pressure is estimated based on the turbine parts pressure measurement values from the turbine parts pressure gauge 130, but this is not restrictive. Any measurement value other than the turbine parts pressure measurement values from the turbine parts pressure gauge 130 may be used as long as it is a measurement value from which the state in each stage in the start-up process of the turbine 10 can be grasped, such as, for example, an output of a wattmeter if the state to be grasped is a turbine load.

Next, the subtracting unit of the thrust contact pressure controller 112c subtracts the thrust bearing contact pressure estimated value calculated by the thrust contact pressure calculating unit 112d, from the thrust contact pressure set value read from the thrust contact pressure set value storage 113c, and outputs the thrust contact pressure deviation (Step S62).

Next, the control element of the thrust contact pressure controller 112c receives the thrust contact pressure deviation as an input, performs the control calculation, and outputs a command for the opening position of the adjustment valves (Step S63). The control calculation is, for example, PI operation, that is, proportional and integral operation.

Upon receiving the opening position command, the output unit 114 outputs the opening position command to the first low pressure-side control valve 121 and the first high pressure-side control valve 122 (Step S70). In this case, the opening position command is a split range command causing an operation of fully opening the first high pressure-side control valve 122 from the fully closed state after fully closing the first low pressure-side control valve 121 from the fully open state, or an operation in the opposite direction, according to the opening position command, as illustrated in the blocks of Steps S31, S41 in FIG. 5 of the first embodiment.

Meanwhile, the temperature monitoring and the correction operation are performed as in the first embodiment. Steps S10, S20, S31 and S41, S32 and S42 corresponding to this flow are the same as those in the first embodiment, and a description thereof will be omitted. Note that the opening position change command at Step S31 and Step S41 is a command for incremental/decremental change amount of the opening position.

As described above, the configuration of the controller 110a in this embodiment ensures the followability to the change of the operation state owing to the thrust contact pressure control loop that is based on the signals from the pressure gauges having quick responsiveness.

Further, even if arithmetic accuracy in the thrust contact pressure calculating unit 112d is low and the estimated value of the thrust contact pressure greatly deviates from a true value, this can be compensated owing to the temperature monitoring and the correction operation, making it possible to keep the temperature of the thrust bearing 30 within an appropriate value range.

If the arithmetic accuracy in the thrust contact pressure calculating unit 112d is ensured or its accuracy is tolerable, the controller 110a may only include the thrust contact pressure control without performing the temperature control.

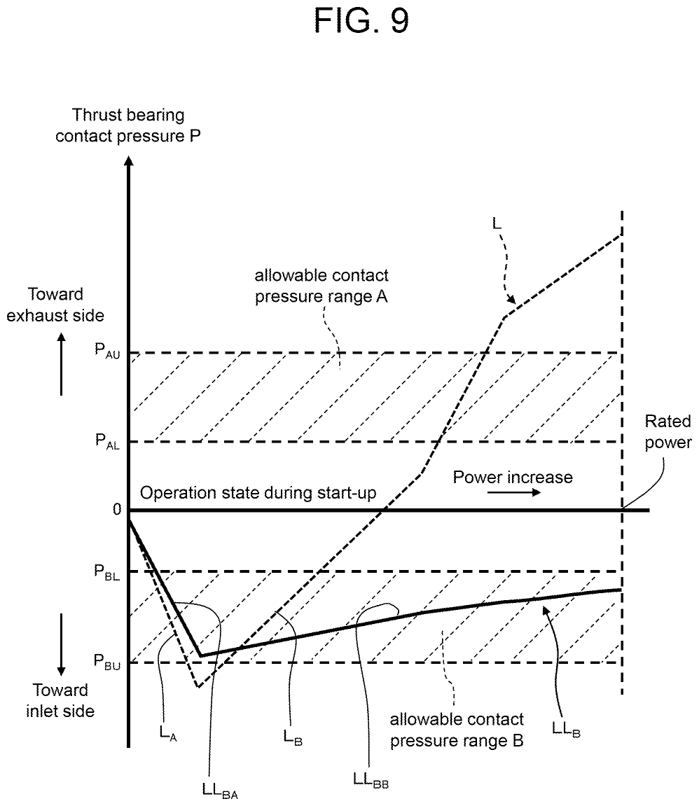

FIG. 9 is a graph illustrating a first example of how the thrust load adjusting mechanism 100 of the turbine 10 according to the second embodiment changes the contact pressure P of the thrust bearing 30 in the start-up process.

The horizontal axis from the left toward the right represents the shift of the operation state, with the origin representing an activation start of the start-up and the right end representing a rated power. The vertical axis represents the contact pressure P of the thrust bearing 30.

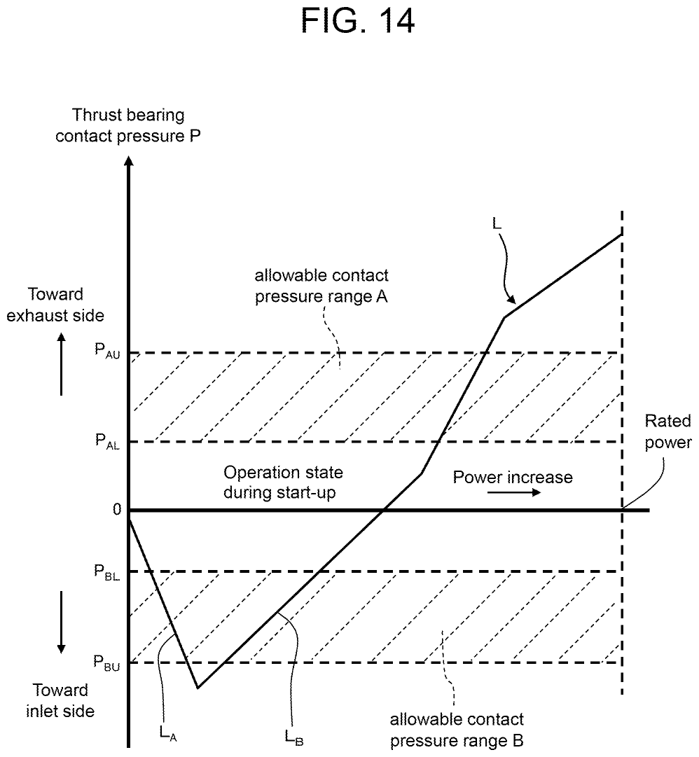

The broken line L represents the contact pressure P of the thrust bearing 30 in the natural state, that is, without the thrust adjustment being performed as illustrated in FIG. 14. Further, the solid line represents the contact pressure P when the thrust adjustment of this embodiment is performed.

Under a low load, an excessive thrust contact pressure toward the inlet side (the left direction in FIG. 3) is applied in the natural state as indicated by the broken line L_{A}. This necessitates applying force toward the exhaust side (the right direction in FIG. 3) to the balance piston 20. Therefore, the thrust contact pressure controller 112c calculates a command signal to the first low pressure-side control valve 121 and the first high pressure-side control valve 122 so as to increase the pressure in the balance piston outer-side chamber 22 from the natural-state pressure P_{2N}, and the output unit 114 outputs the command signal.

Contrarily, under a high load, the thrust contact pressure toward the exhaust side (the right direction in FIG. 3) is excessively applied in the natural state as indicated by the broken line L_{B}. This necessitates applying force toward the inlet side (the left direction in FIG. 3) to the balance piston 20. Therefore, the thrust contact pressure controller 112c calculates a command signal to the first low pressure-side control valve 121 and the first high pressure-side control valve 122 so as to decrease the pressure in the balance piston outer-side chamber 22, and the output unit 114 outputs the command signal.

The stage of increasing the pressure in the balance piston outer-side chamber 22 from the natural state by the pressure of the high-pressure region 120b and the stage of decreasing its pressure from the natural state by the pressure of the low-pressure region 120a are thus combined. As a result, the operation during which the contact pressure between the rotation-side disk second face 33 and the thrust bearing receiving member second face 37 is adjusted to a value within the allowable contact pressure range B is achieved in the entire operation region in the start-up process of the turbine 10.

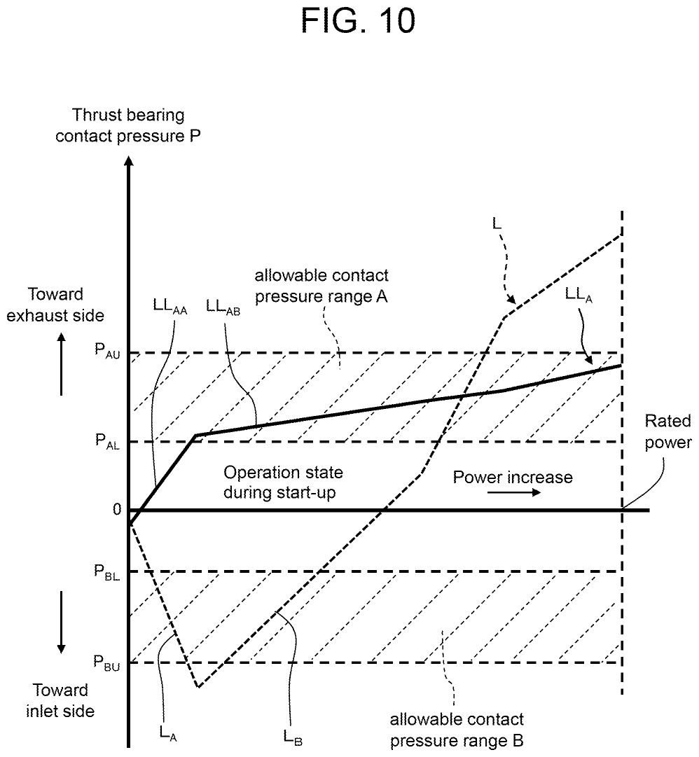

FIG. 10 is a graph illustrating a second example of how the thrust load adjusting mechanism 100 of the turbine 10 according to the second embodiment changes the contact pressure P of the thrust bearing 30 in the start-up process.

In this example, the contact pressure between the rotation-side disk first face 32 and the thrust bearing receiving member first face 36, which are the surfaces opposite those in the first example, is adjusted. Specifically, in the initial period of the start-up of the turbine 10, the pressure in the balance piston outer-side chamber 22 is increased from the natural state by the pressure of the high-pressure region 120b, and thereafter, force toward the inlet side (the left direction in FIG. 3) is applied to the balance piston 20 to supress the excessive application of the thrust contact pressure toward the exhaust side (the right direction in FIG. 3), that is, the command signal to the first low pressure-side control valve 121 and the first high pressure-side control valve 122 is calculated so as to decrease the pressure in the balance piston outer-side chamber 22, and the output unit 114 outputs the command signal.

The stage of increasing the pressure in the balance piston outer-side chamber 22 from the natural state by the pressure of the high-pressure region 120b and the stage of decreasing its pressure from the natural state by the pressure of the low-pressure region 120a are thus combined. As a result, the operation during which the contact pressure between the rotation-side disk first face 32 and the thrust bearing receiving member first face 36 is adjusted to a value within the allowable contact pressure range A is achieved in the entire operation region in the start-up process of the turbine 10.

As described above, the controller according to this embodiment achieves the operation during which the contact pressure of the thrust bearing 30 is maintained within the allowable contact pressure range, in the entire operation region in the start-up process of the turbine 10 and at the same time, ensures responsiveness and accuracy.

[Third Embodiment]

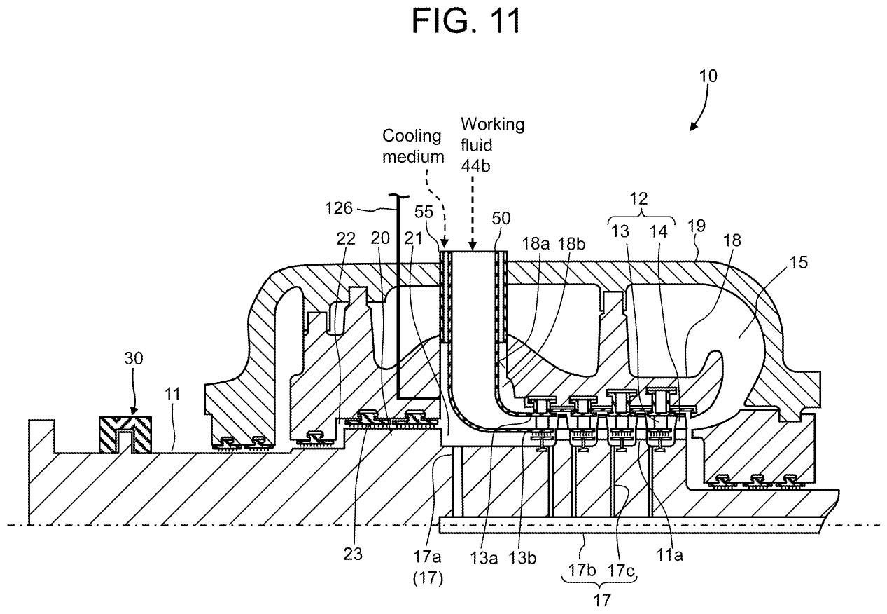

FIG. 11 is an axial-direction sectional view of the upper half of a turbine 10 according to a third embodiment.

This embodiment is a modification of the first embodiment, and a thrust load adjusting mechanism 100b in this embodiment has an adjusting pipe 126 connected to a cooling medium inlet chamber 18b, and the cooling medium inlet chamber 18b can communicate with a high-pressure region 120b and a low-pressure region 120a. This embodiment is the same as the first embodiment except this.

As a result, a pressure in a balance piston inner-side chamber 21 is changeable from a pressure P_{1N} in a natural state both in an increasing direction and a decreasing direction, making it possible to adjust a contact pressure of a thrust bearing 30 to a wide range.

Further, as in the first embodiment, a first low pressure-side control valve 121 and a first high pressure-side control valve 122 whose one-side ends are connected to the low-pressure region 120a and the high-pressure region 120b (FIG. 1) respectively join into the single adjusting pipe 126 at the other sides, which is advantageous in arranging the pipes near the turbine 10.

As described above, according to the third embodiment of the present invention, it is possible to obtain the same effects as those of the first embodiment, and thus it is possible to obtain a degree of freedom in selecting the balance piston inner-side chamber 21 as a place other than the balance piston outer-side chamber 22.

[Fourth Embodiment]

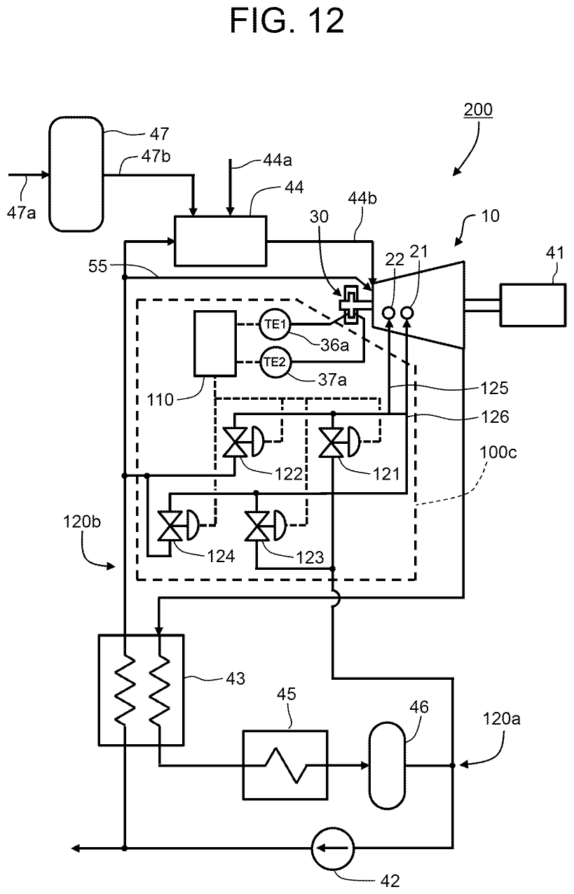

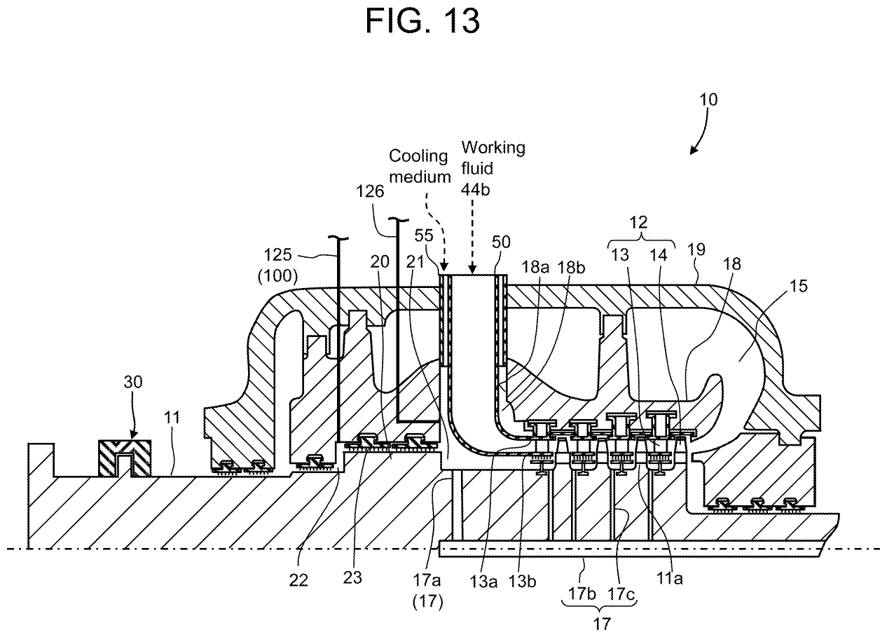

FIG. 12 is a system diagram illustrating the configurations of a turbine system 200 including a turbine 10 and a thrust load adjusting mechanism 100c according to a fourth embodiment. FIG. 13 is an axial-direction sectional view of the upper half of the turbine 10 according to the fourth embodiment.

This embodiment is a modification of the first embodiment and the third embodiment and is a combination of these. Specifically, the thrust load adjusting mechanism 100c in this embodiment has an adjusting pipe 125 connected to a balance piston outer-side chamber 22 and has an adjusting pipe 126 connected to a balance piston inner-side chamber 21, and the balance piston outer-side chamber 22 and the balance piston inner-side chamber 21 each can communicate with a low-pressure region 120a and a high-pressure region 120b (FIG. 1). The other configuration is the same as that of the first embodiment.

The adjusting pipe 126 is connected to a second low pressure-side control valve 123 connected to the low-pressure region 120a, and is connected to a second high pressure-side control valve 124 connected to the high-pressure region 120b.

As a result, it is possible to independently adjust a pressure in the balance piston inner-side chamber 21 and a pressure in the balance piston outer-side chamber 22. As a result, by combining both, it is possible to adjust a contact pressure of a thrust bearing 30 to a still wider range.

[Other Embodiments]

While certain embodiments of the present invention have been described above, these embodiments have been presented by way of example only, and are not intended to limit the scope of the invention. As previously described, the embodiments show the system using the CO₂ gas turbine as an example of the turbine system 200, but the features of the thrust load adjusting mechanisms in these embodiments are also applicable to systems using other gas turbines and steam turbines.

Specifically, a piping system on a higher-pressure side than a natural-state pressure of an adjustment target part can be a high-pressure region, and a piping system on a lower-pressure side than a natural-state pressure of the adjustment target part can be a low-pressure region.

For example, in a multi-shaft steam turbine, if it is a high-pressure turbine, a pipe from a steam generating part such as a boiler up to a turbine inlet or the boiler itself can be a high-pressure region, and a piping system on a lower-pressure side than a natural-state pressure of an adjustment target part in or after an intermediate-pressure turbine, an extraction pipe on a downstream stage, a turbine exhaust chamber, or the like can be a low-pressure region.

As for an intermediate-pressure turbine, a region including an extraction pipe or the like of a high-pressure turbine can be a high-pressure region, and a low-pressure turbine side can be a low-pressure region. Further, as for a low-pressure turbine, a high pressure exhaust-side pipe, an extraction pipe of an intermediate-pressure turbine, or the like can be a high-pressure region, and a turbine exhaust chamber or the like can be a low-pressure region.

The embodiments may be combined with each other. For example, the feature of the controller shown in the second embodiment and each feature of the third embodiment and the fourth embodiment may be combined with each other.

The embodiments may be embodied in other various forms. Various omissions, replacements and changes may be made without departing from the spirit of the invention.

The above-described embodiments and variants thereof are within the scope and spirit of the invention, and are similarly within the scope of the invention defined in the appended claims and the range of equivalency thereof.

What is claimed is:

1. A turbine comprising:
a casing;
a rotor shaft penetrating the casing;
a plurality of turbine stages arranged in the casing along an axial direction of the rotor shaft;
a thrust bearing which receives thrust load in the axial direction generated by a flow of a working fluid supplied to the turbine stages;
a balance piston which is formed on the rotor shaft along a circumferential direction and projects in a radial direction from the rotor shaft, for adjusting a thrust contact pressure applied to the thrust bearing; and
a thrust load adjusting mechanism which applies pressures of a pressure-increasing side and a pressure-decreasing side to at least one of a balance piston inner-side chamber and a balance piston outer-side chamber which sandwich the balance piston in the axial direction.

2. The turbine according to claim 1,
wherein the thrust load adjusting mechanism comprises:
a low pressure-side pipe connected to a low-pressure region;
a high pressure-side pipe connected to a high-pressure region;
a low pressure-side control valve disposed on the low pressure-side pipe;
a high pressure-side control valve disposed on the high pressure-side pipe; and
a controller which outputs an opening/closing command to the low pressure-side control vale and the high pressure-side control valve,
wherein the low pressure-side pipe and the high pressure-side pipe communicate with at least one of the balance piston inner-side chamber and the balance piston outer-side chamber.

3. The turbine according to claim 2,
wherein the thrust load adjusting mechanism further comprises an adjusting pipe having one end connected to the low pressure-side pipe and the high pressure-side pipe and having another end communicating with at least one of the balance piston inner-side chamber and the balance piston outer-side chamber.

4. The turbine according to claim 2,
wherein the controller comprises:
a recognizing unit which recognizes an operation state;
a thrust contact pressure calculating unit which derives a thrust contact pressure estimated value from a value obtained by the recognizing unit, and
a thrust contact pressure controller including a subtracting unit which subtracts the thrust contact pressure estimated value from a thrust bearing contact pressure set value stored in advance and outputs a thrust contact pressure deviation, and a control element which performs a control calculation based on the thrust contact pressure deviation and outputs an opening position command signal.

5. The turbine according to claim 4,
wherein the obtained value is a pressure of each part of the turbine.

6. The turbine according to claim 4,
wherein the obtained value is a parameter corresponding to a load of the turbine.

7. A thrust load adjusting method of a turbine including a balance piston which is formed in a rotor shaft along a circumferential direction and projects in a radial direction from the rotor shaft, to adjust a thrust contact pressure applied to a thrust bearing, the method comprising:
a thrust contact pressure estimating step of deriving, by a thrust contact pressure calculating unit, a thrust contact pressure estimated value from a measurement value related to an operation state;
a set value reading step of reading, by a thrust contact pressure controller, a thrust bearing contact pressure set value from a thrust contact pressure calculation data storage;
a deviation calculating step of subtracting, by a subtracting unit of the thrust contact pressure controller, the thrust contact pressure estimated value from the thrust bearing contact pressure set value to output a thrust contact pressure deviation; and
a control calculation step of performing, by a control element of the thrust contact pressure controller, a control calculation based on the thrust contact pressure deviation, and outputting an opening position command signal to an control valve which applies pressures of a pressure-increasing side and a pressure-decreasing side to at least one of a balance piston inner-side chamber and a balance piston outer-side chamber which sandwich the balance piston in an axial direction.

8. The thrust load adjusting method according to claim 7, further comprising:
a determining step of determining whether or not a temperature of the thrust bearing is in an adjustment requiring region; and
an arithmetic step of, when it is determined in the determining step that the temperature of the thrust bearing is in the adjustment requiring region, performing an arithmetic operation to generate an opening/closing command for the control valve so as to return the temperature to a temperature region corresponding to an allowable contact pressure range, and outputting a signal of the command to the control valve.
